(19) United States
(12) Patent Application Publication
(10) Pub. No.: US 2022/0009284 A2
(43) Pub. Date: Jan. 13, 2022

(54) TIRE WITH INSERT

(71) Applicant: COMPAGNIE GENERALE DES ETABLISSEMENTS MICHELIN, CLERMONT-FERRAND (FR)

(72) Inventors: JOSE MERINO LOPEZ, CLERMONT-FERRAND (FR); NATHALIE COSTE, CLERMONT-FERRAND (FR); FREDERIC PIALOT, CLERMONT-FERRAND (FR); MATHIEU DELBOS, CLERMONT-FERRAND (FR)

(21) Appl. No.: 16/321,548

(22) PCT Filed: Jul. 14, 2017
(86) PCT No.: PCT/IB2017/054269

§ 371 Date: Jan. 29, 2019

(30) Foreign Application Priority Data
Jul. 29, 2016 (FR) 1670415

(51) Int. Cl. B60C 1/00; C08L 21/00; C08K 5/17

(52) U.S. Cl. CPC B60C 1/0025; B60C 1/0008; C08L 7/00; C08K 5/17; B60C 2001/0033; C08L 21/00

(57) ABSTRACT

A tire comprises sidewalls (2), a crown region (3) provided with a tread (4), and a reinforcing structure (5) extending between the sidewalls (2) and passing via the crown region (3). At least one portion of the region of the tire that is axially inside the reinforcing structure (5) comprises an insert (6) comprising a first elastomer composition serving as a matrix, within which a second elastomer composition originating from recycled tires is distributed substantially uniformly, the proportion of said second elastomer composition being greater than or equal to 40%.

### TECHNICAL FIELD OF THE INVENTION

The present invention relates to a tyre. It relates more particularly to a tyre composed of a high proportion of powder from recycled tyres.

### PRIOR ART

The field of tyres is subject to numerous requirements. This is because tyres must offer guarantees of safety, durability and good performance properties.

Tyres are subject to significant external attacks such as from potholes or else pavements. It is therefore important for them to have high strength.

Moreover, environmental concerns have led to the development of more environmentally-friendly products at the present time. The use of a powder of rubber compound from recycled tyres is especially known. This powder consists of residues of worn tyres (or new tyres with manufacturing defects) which are disassembled using specially designed machines, making it possible to recover the vulcanized rubber materials and to extract the textile and metal reinforcers. The extracted rubber materials are then ground to make a powder therefrom (sometimes referred to as “crumb rubber” because of the very small size of the particles obtained). A powder of this type may be used in numerous applications where it is desired to incorporate recycled materials, whether for economic and/or environmental reasons.

Document KR2009068400 describes the rubber composition of a tyre inner liner. This inner liner is a mixture of halobutyl rubber, of natural rubber, of recycled butyl rubber, of carbon black and a small amount of waste tyre powder.

Document EP2104710 describes a tyre tread composed of a powder of xanthan gum in a proportion of 10 to 40 phr.

Generally speaking, for tyres, the use of powders of recycled materials remains limited to low proportions, mainly so as not to adversely affect the performance properties of the tyre.

Document DE102009003333 describes a tyre comprising, under the crown region, an additional self-sealing layer. This layer consists of viscoelastic gel, preferentially composed of 30% recycled powder. This additional layer is provided for a specific function of sealing any obstructions of the tyre tread caused by intrusive objects such as nails. The self-sealing layer does not contribute to the carrier structure function of the tyre.

Document FR2864469 discloses a self-supporting tyre with sidewalls reinforced using inserts arranged in the sidewalls. The inserts consist of rubber compositions, enabling the sidewalls to support a load corresponding to a portion of the weight of the vehicle in a situation in which the inflation pressure is reduced or zero. This tyre does not use recycled materials.

Document EP1454942 discloses a process making it possible to treat powders of recycled tyres in order to improve the properties thereof, in particular resistance to abrasion and to crack propagation.

The invention provides various technical means for alleviating these various drawbacks.

### SUMMARY OF THE INVENTION

Firstly, a first object of the invention consists in enabling a large-scale use of residues from tyres that have reached the end of their life.

Another object of the invention consists in decreasing the raw material costs of tyres while ensuring the quality level of the products manufactured is maintained.

Another object of the invention consists in providing a tyre composed to a large extent of materials originating from tyres at the end of their life, without losing the performance of the tyre.

Yet another object of the invention consists in decreasing the raw material costs of tyres while making it possible to reduce the risks of cracking by chemical and/or UV attack.

Another object of the invention consists in providing a tyre with reduced cost.

For this purpose, the invention provides a tyre comprising sidewalls, a crown region provided with a tread, with a reinforcing structure extending between the sidewalls and passing via the crown region, said sidewalls, said crown region and said reinforcing structure forming a bearing structure delimited internally by a tyre inner wall, at least a portion of the region of the tyre located between the reinforcing structure and the inner wall comprising an insert structurally forming part of the bearing structure and comprising a first elastomer composition serving as a matrix, within which a second elastomer composition originating from recycled tyres is distributed substantially uniformly, the proportion of said second elastomer composition being greater than or equal to 40%.

According to such an architecture, the use of a high content of tyre powder enables a reduction in the costs of raw materials while enabling an advantageous reuse of recycled materials.

According to an advantageous embodiment, the first composition is a rubber composition.

According to another advantageous embodiment, the second elastomer composition is present in an amount greater than or equal to 60%, and more preferentially greater than or equal to 80%.

The higher the content, the lower the manufacturing costs, without risk of loss of performance for the tyre due to the architecture specifically provided for this purpose.

According to various embodiments, the insert is located under the crown region or along at least one of the sidewalls in the radial direction, or in at least one axial end of the reinforcing structure, also referred to as shoulder.

This specific location of the insert provides an anti-creep effect of the compounds through the reinforcers. This effect is particularly useful during the manufacture of tyres.

According to yet another advantageous embodiment, the insert is covered with an airtight layer devoid of elastomer composition originating from recycled tyres. This airtight layer is provided so as to be in contact with the inflation gas of the tyre.

This airtight layer preferably comprises more than 50 phr of butyl.

The airtight layer advantageously comprises antioxidant elements, such as, for example, 6 PPD.

According to yet another advantageous embodiment, the second elastomer composition originating from recycled tyres has a particle size distribution of less than or equal to 1 mm and preferentially less than or equal to 0.5 mm and even more preferentially of less than or equal to 0.2 mm of mean diameter of each of the particles.

This very fine particle size distribution facilitates the preparation of the mixture required to manufacture the insert and promotes the production of a homogeneous mixture.

According to an advantageous embodiment, the first elastomer composition has a high content of antioxidants, such as for example 6 PPD, at a content advantageously of greater than 2 phr.

### DESCRIPTION OF THE FIGURES

All the embodiment details are given in the following description, supplemented by the single figure presented solely for the purposes of non-limiting examples, and illustrating a cross-sectional view of an embodiment of a tyre provided with an insert arranged in the vicinity of the tyre cavity.

### DETAILED DESCRIPTION OF THE INVENTION

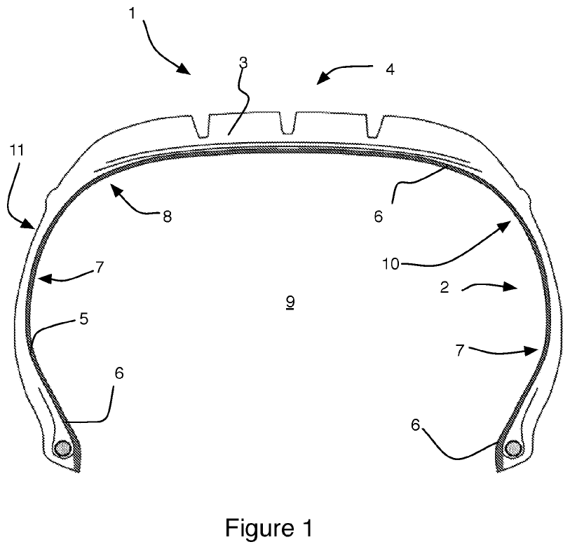

FIG. 1 is a schematic representation of a sectional view of an example tyre comprising sidewalls 2 and a crown region 3 provided with a tread 4. As illustrated, the tyre provides a reinforcing structure 5 which extends from one sidewall to the other, passing via the crown region 3.

The sidewalls 2, the crown region 3 and the reinforcing structure 5 form a bearing structure suitable for supporting a part of the load corresponding to the weight of the vehicle and the restrictions related to the use of the vehicle. The bearing structure is delimited internally by the inner walls 10 and outer walls 11 of the tyre.

At least a portion of the region of the tyre that is axially inside the reinforcing structure 5 comprises an insert 6 in the (direct or indirect) vicinity of the cavity 9 of the tyre. The insert 6 is thus located between the reinforcing structure 5 and the tyre inner wall 10.

This insert consists of a first elastomer composition serving as a matrix, within which a second elastomer composition originating from recycled tyres is distributed substantially uniformly.

The proportion of second elastomer composition is greater than or equal to 40% and more preferentially greater than or equal to 60%, and even more preferentially greater than or equal to 80%.

The second elastomer composition has a particle size distribution of less than or equal to 1 mm and preferentially less than or equal to 0.5 mm and even more preferentially less than or equal to 0.2 mm of mean diameter of each of the particles.

In the example illustrated, the insert 6 passes through the whole of the inner region of the tyre, from one bead to the other. According to various embodiment variants, the insert is located in a narrower portion, such as, for example, in the radial direction in at least one of the sidewalls 2, or along the crown region 3, under the latter, or else in the shoulder region 8 of the tyre.

As illustrated, the insert is covered, on the side of the tyre cavity 9, with an airtight layer 7. This layer is devoid of elastomer composition originating from recycled tyres. It advantageously comprises more than 50 phr of butyl. It advantageously comprises antioxidant elements, such as, for example, 6 PPD.

The insert according to the invention may be used in any type of tyre. The advantages thereof are notable on tyres for heavy goods vehicles or civil engineering. For example, in the case of tyres for civil engineering, the thickness of the insert may be greater than 5 mm and, for some tyre sizes, may reach 8 to 10 mm.

### Reference Numerals Employed in the Figures

1 Tyre
2 Sidewall
3 Crown region
4 Tread
5 Reinforcing structure
6 Insert
7 Airtight layer
8 Shoulder
9 Cavity of the tyre
10 Tyre inner wall

1.-12. (canceled)

13. A tire comprising sidewalls, a crown region provided with a tread, with a reinforcing structure extending between the sidewalls and passing via the crown region, the sidewalls, the crown region and the reinforcing structure forming a bearing structure delimited internally by a tire inner wall,
wherein at least a portion of the region of the tire located between the reinforcing structure and the tire inner wall comprises an insert structurally forming part of the bearing structure and comprising a first elastomer composition serving as a matrix, within which a second elastomer composition originating from recycled tires is distributed substantially uniformly, the proportion of the second elastomer composition being greater than or equal to 40%.

14. The tire according to claim 13, wherein the first elastomer composition is a rubber composition.

15. The tire according to claim 13, wherein the second elastomer composition is present in an amount greater than or equal to 60%.

16. The tire according to claim 13, wherein the second elastomer composition is present in an amount greater than or equal to 80%.

17. The tire according to claim 13, wherein the insert is located under the crown region.

18. The tire according to claim 13, wherein the insert is located along at least one of the sidewalls in the radial direction.

19. The tire according to claim 13, wherein the insert is located in at least one axial end of the reinforcing structure.

20. The tire according to claim 13, wherein the insert is covered with an airtight layer devoid of elastomer composition originating from recycled tires.

21. The tire according to claim 20, wherein the airtight layer comprises more than 50 phr of butyl.

22. The tire according to claim 20, wherein the airtight layer comprises antioxidant elements.

23. The tire according to claim 13, wherein the second elastomer composition originating from recycled tires has a particle size distribution of less than or equal to 1 mm of mean diameter of each of the particles.

24. The tire according to claim 23, wherein the second elastomer composition originating from recycled tires has a particle size distribution of less than or equal to 0.5 mm of mean diameter of each of the particles.

25. The tire according to claim 24, wherein the second elastomer composition originating from recycled tires has a particle size distribution of less than or equal to 0.2 mm of mean diameter of each of the particles.

26. The tire according to claim 13, wherein the first elastomer composition has a high content of antioxidants.
